(19) United States
(12) Patent Application Publication
(10) Pub. No.: US 2013/0191731 A1
(43) Pub. Date: Jul. 25, 2013

(54) DISPLAY CONTROL METHOD, AND DISPLAY CONTROL APPARATUS

(71) Applicant: Fujitsu Limited, Kawasaki-shi (JP)

(72) Inventor: Yutaka Yamanaka, Kannami (JP)

(73) Assignee: FUJITSU LIMITED, Kawasaki-shi (JP)

(21) Appl. No.: 13/718,543

(22) Filed: Dec. 18, 2012

(30) Foreign Application Priority Data
Jan. 25, 2012 (JP) 2012-013584

(51) Int. Cl. G06F 17/21

(52) U.S. Cl. CPC G06F 17/21
USPC 715/246; 715/273

(57) ABSTRACT

A display control method includes obtaining displaying data, and displaying the displaying data on a display device by a processor, wherein when a displaying element group includes a specific number or more of display elements, the displaying data includes display elements which are included in the display element group and satisfy a specific condition.

### CROSS-REFERENCE TO RELATED APPLICATION

This application is based upon and claims the benefit of priority of the prior Japanese Patent Application No. 2012-13584, filed on Jan. 25, 2012, the entire contents of which are incorporated herein by reference.

### FIELD

The embodiments discussed herein are related to display of document data.

### BACKGROUND

Web files may include description regarding switching of display/undisplay of information in accordance with input to a terminal using, for example, JavaScript (registered trademark). Switching of display/undisplay of a part of information in the Web file is achieved by causing the Web file including such description to be displayed by the process in accordance with a Web browser program. If the Web file includes no description about the switching of display/undisplay of information (e.g., if the Web file is described by hypertext markup language (HTML)), each display element included in the Web file is displayed as described in the Web file.

There is a technique to delete a keyword (keyphrase), or a paragraph or a Web page including such a keyword (keyphrase), or to replace a keyword (keyphrase), or a paragraph or a Web page including such a keyword (keyphrase) with other keyword (keyphrase), paragraph or Web page, in document data for which a distribution request is made.

A Web file includes information which specifies display elements, such as characters and images, and display configurations (layouts) thereof. Some Web files include, as layout specification, portions in which forms of arrangement of information are specified (for example, table and listing). For example, when pieces of information about independent events related to a certain common theme are listed, these pieces of information are arranged as a table or a list. However, since the arranged pieces of information are related to independent events, desired information of a viewer of the Web file may be a part of enormous amount of arranged information. In such a case, the viewer has to locate the desired information from among the enormous amount of arranged information.

If, however, information which satisfy conditions, such as “including a keyword (keyphrase),” is excluded simply in an existing method, information which satisfy the conditions is excluded also in areas other than the area in which the enormous pieces of information are arranged and the remaining information is displayed. For example, if information which a viewer does not desire is included as a portion which implements a tab function in a Web page the viewer is viewing, the viewer may then seek other information from the tab. In such a case, if the tab is excluded from the Web page, functions originally provided by the Web page are lost and, therefore, manipulation by the viewer is restricted.

### SUMMARY

According to an aspect of the invention, a display control method includes obtaining displaying data, and displaying the displaying data by a processor, wherein when a displaying element group includes a specific number or more of display elements, the displaying data includes display elements which are included in the display element group and satisfy a specific condition.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates exemplary screen information.

FIG. 2 illustrates exemplary screen information.

FIG. 3 illustrates an exemplary functional configuration of a computer.

FIG. 4 illustrates an exemplary hardware configuration of the computer.

FIG. 5 illustrates an exemplary software configuration of the computer.

FIG. 6 illustrates an exemplary system configuration including the computer.

FIG. 7 illustrates exemplary description of HTML included in a Web file.

FIG. 8 illustrates an exemplary process flow of a screen generation unit.

FIG. 9 illustrates a DOM tree in accordance with HTML description.

FIG. 10A illustrates exemplary data structures corresponding to the DOM tree.

FIG. 10B illustrates exemplary data structures corresponding to the DOM tree.

FIG. 11A illustrates exemplary data structures corresponding to the DOM tree.

FIG. 11B illustrates exemplary data structures corresponding to the DOM tree.

FIG. 12A illustrates exemplary data structures corresponding to the DOM tree.

FIG. 12B illustrates exemplary data structures corresponding to the DOM tree.

FIG. 13 illustrates an exemplary process flow to extract a correction candidate.

FIG. 14 illustrates exemplary collation information.

FIG. 15 illustrates an exemplary input screen.

FIG. 16 illustrates an exemplary process flow of condition input.

FIG. 17 illustrates exemplary storage of condition information.

FIG. 18 illustrates an exemplary table.

FIG. 19 illustrates an exemplary process flow to determine whether condition information is satisfied.

### DESCRIPTION OF EMBODIMENTS

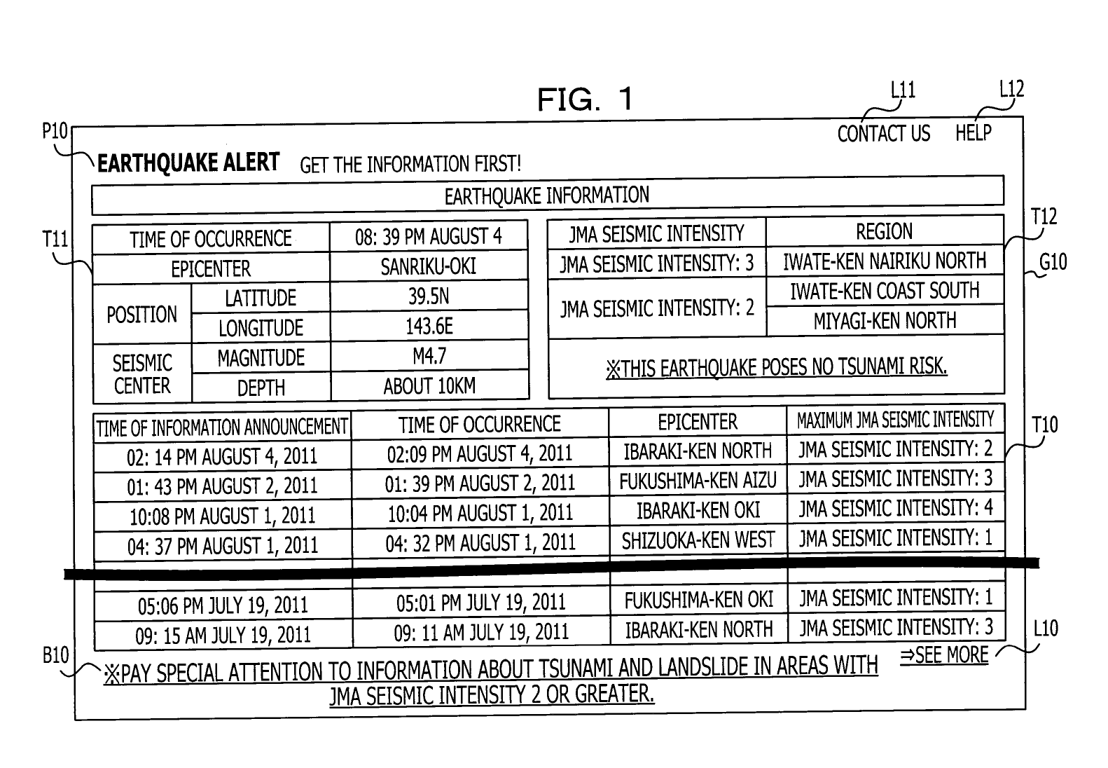

FIG. 1 illustrates exemplary screen information G10 generated using a function of a Web browser in accordance with a Web file 100 acquired by a computer. The Web file 100 includes description by a markup language, such as HTML. In the generated screen information G10, image information, such as P10, link information, such as L10, L11 and L12, table information, such as T10, T11, and T12, and text information, such as B10, which are described in the Web file 100 are arranged at specified positions. Some of the records which are included in the table T10 are not displayed in FIG. 1.

A Web file creator combines information to be provided and creates a Web file. The Web file 100 for generating the screen information G10 is constituted by a combination of, for example, the table T10, the text information B10 and the tables T11 and T12 as the information of earthquake alert. The table T10 is a component in which earthquake archives are displayed. The text information B10 is a component in which notification about the earthquake is displayed. The tables T11 and T12 are components in which the latest earthquake information is displayed.

Here, the table T10 will be described as an example. In the table T10, “records,” which are the same type of information, are arranged in an area in which a display form of “table” is specified. That is, the display form is set collectively for the records. Arrangement of information in the display form as that of the table T10 is used in a case in which information about independent events have a common theme. For example, in the table form as illustrated in table T10, each column has an item name and each arranged record includes information having a common theme represented by the item name of each column (for example, listing is a form used to arrange plural events about a certain theme.) For example, in the table T10 included in the screen information G10, the records included in the T10 include information corresponding to common item names of “time of information announcement,” “time of occurrence,” “epicenter,” and “maximum JMA seismic intensity.” Each record is information related to an independent earthquake event, that is, an independent event.

In a table in which independent events having a common theme are arranged, e.g., the table T10, the characteristic of the table that independent events having a common theme are arranged is unchanged even after one of the pieces of the arranged information is excluded. For example, even after a row of record is excluded from the table T10, the table T10 still is the component which displays the earthquake archives in the Web page.

Regarding the link information L11, L12 and L13, a display form of “link” is specified and regarding the text information B10, a display form of, for example, “paragraph” is specified for information display. Display elements themselves are components of the Web page. If, for example, the text information B10 is excluded, the Web page includes no notification about the earthquake and the configuration of the entire Web page changes.

A display device on which the generated screen information G10 is displayed has a limited area in which the screen information G10 is displayed. A display area of the display device is defined in accordance with, for example, the resolution, size and other setting, of the display device. If the display device is not able to display the screen information G10 in the display area, the display device makes the control to slide the display area or to change magnification so as to cause the screen information G10 to be displayed. That is, in order to display, in the display device of which display area is previously defined, the screen information G10 which includes the table T10 increased in size with a greater amount of information to be arranged, the viewer has to input a display control instruction in the display device.

The information to be used by the viewer who instructed the display of the screen information may be only a part of the information arranged in the screen information. Especially if the theme which is common to the arranged information is broader in concept than the matter the viewer has to use, information unnecessary to the viewer may be included in the arranged information. In that case, the display area is allocated to such unnecessary information and, as a result, the viewer has to input the instruction in the display device to cause the information of interest to be displayed.

In order to avoid such a situation, regarding information arranged in the same layout setting and displayed in the same display form, the following process may be performed: for example, conditions to exclude information to be displayed are specified; information which satisfies the specified conditions is excluded; and the remaining screen information is generated. That is, the process to exclude the information which satisfies the specified conditions is performed to the information arranged in the same display form (i.e., the information arranged in the same display form is considered as a correction candidate). Alternatively, if the number of pieces of information arranged in the same form is greater than the predetermined number, the process to exclude the information which satisfies the specified conditions is performed. The predetermined number is set previously or defined by an input at the time of displaying the Web file 100, for example. In contrast, processes to specify conditions to display information and to exclude information which does not satisfy specified conditions may be performed.

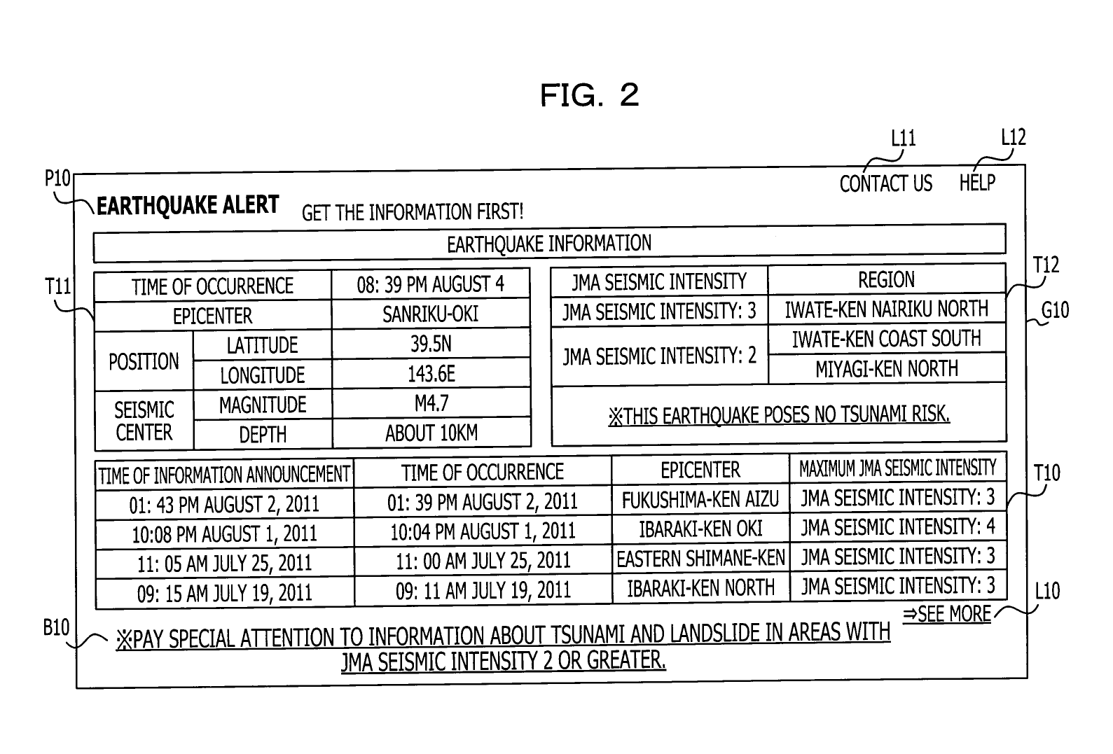

FIG. 2 illustrates a screen information G20 generated on the basis of the Web file 100 of the screen information G10 from which information satisfying conditions of “related to “JMA seismic intensity 1” and “JMA seismic intensity 2”” is excluded. FIG. 2 illustrates a case in which the predetermined number is equal to or greater than four. The screen information G20 includes a table T20 which is a result after display elements (i.e., records) arranged in the same form are excluded from the table T10.

In the table T20, a record of “JMA seismic intensity 2” of which epicenter is “Ibaraki-ken North,” a record of “JMA seismic intensity 1” of which epicenter is “Suruga-Bay,” a record of “JMA seismic intensity 1” of which epicenter is “Western Shizuoka-ken,” and so forth which have existed in the table T10 are excluded.

In contrast, the text information B10 is not excluded in the screen information G20 although the text information B10 includes a character string of “JMA seismic intensity 2.” This is because the text information B10 is not a portion at which a predetermined or greater number of display elements are specified to be arranged in the same display form. The record related to “JMA seismic intensity 2” of a table T12 is not excluded either from the same reason as that of the text information B10.

As described above, regarding the information arranged in the same display form, screen information which is easy to view information in accordance with the specified conditions and is less subject to change in the entire screen configuration can be generated by the process to exclude information which satisfies the specified conditions.

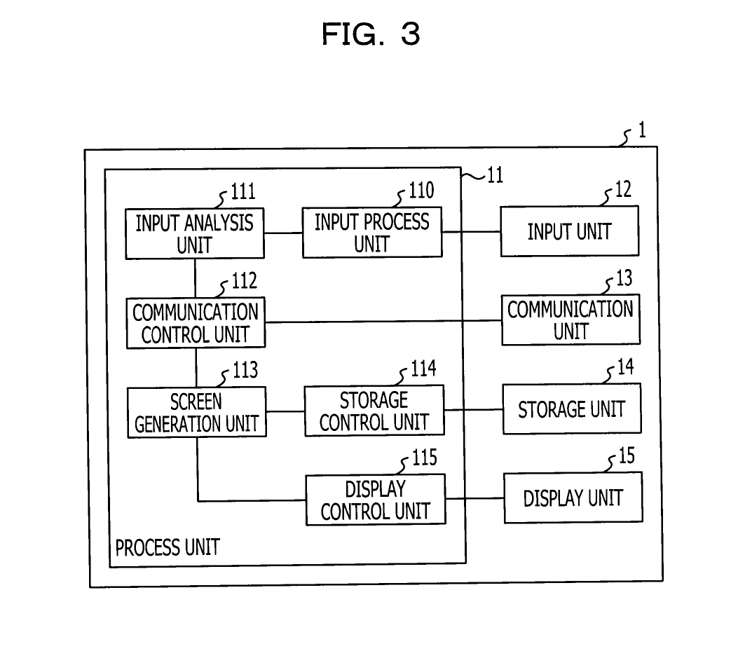

Hereinafter, an embodiment will be described with reference to the drawings. A configuration of a computer 1 of the embodiment will be described with reference to FIGS. 3 to 5.

FIG. 3 illustrates an exemplary functional configuration of the computer 1. The computer 1 includes a process unit 11, an input unit 12, a communication unit 13, a storage unit 14 and a display unit 15. The process unit 11 includes an input process unit 110, an input analysis unit 111, a communication control unit 112, a screen generation unit 113, a storage control unit 114 and a display control unit 115.

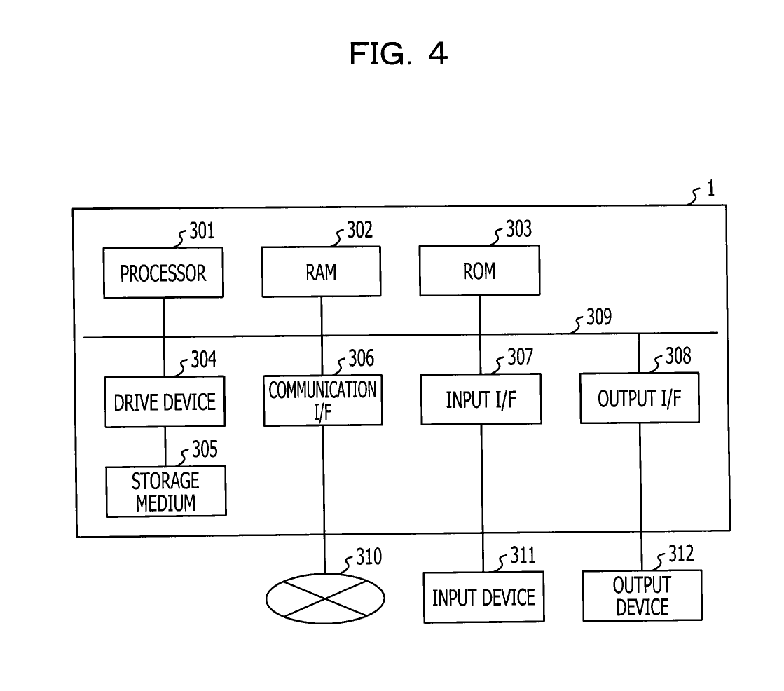

FIG. 4 illustrates an exemplary hardware configuration of the computer 1. The computer 1 includes a processor 301, random access memory (RAM) 302, read only memory (ROM) 303, a drive device 304, a recording medium 305, a communication interface (I/F) 306, an input interface (I/F) 307 and an output interface (I/F) 308. The processor 301, the RAM 302, the ROM 303, the drive device 304, the communication interface 306, the input interface 307 and the output interface 308 are connected via a bus 309. The communication interface 306 is connected to a network 310. The input interface 307 is connected to an input device 311. The output interface 308 is connected to an output device 312.

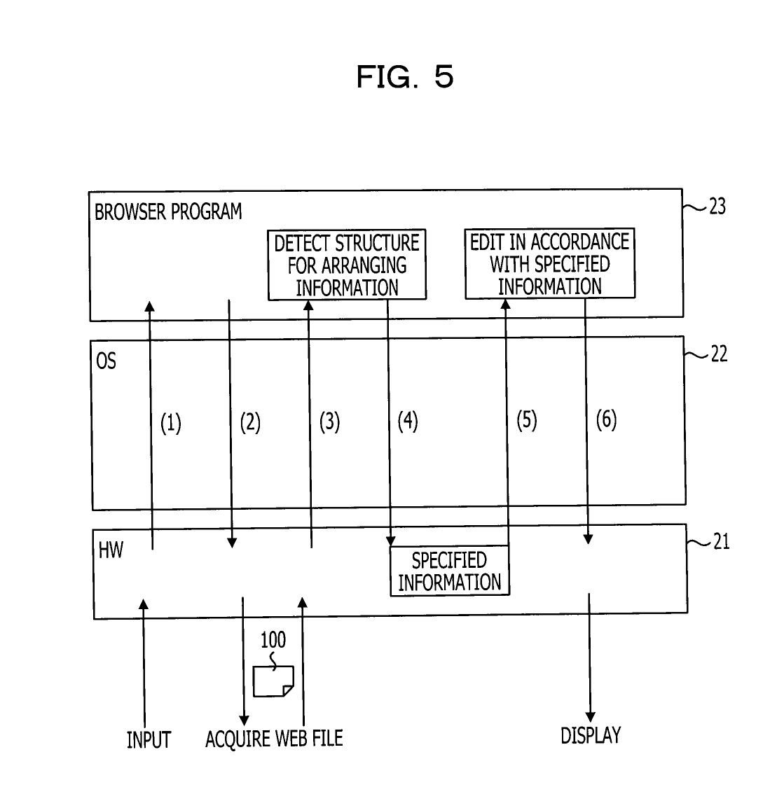

FIG. 5 illustrates an exemplary software configuration of the computer 1. The computer 1 causes a browser program 23 to operate. In the computer 1, an operation system (OS) 22 is operated for the control and management to cause hardware (HW) 21 to perform processes by the browser program 23 or an unillustrated application program. The hardware 21 is the hardware described above with reference to FIG. 4. Arrows (1) to (6) in FIG. 5 indicate process flows in the embodiment.

Each configuration of the computer 1 illustrated in FIG. 3 will be described.

The function of the process unit 11 is implemented by, for example, the processor 301 performing arithmetic operations in accordance with the OS 22, the browser program 23, or other unillustrated application program, and performing control operations of the hardware included in the computer 1. The input unit 12 transfers input information to the input process unit 110. The function of the input unit 12 is implemented by an input I/F 307 transferring, to the processor 301, a signal in accordance with input manipulation detected by the input device 311.

The input process unit 110 determines by which program operating on the computer 1 the input information transferred from the input unit 12 is to be processed, and causes the determined program to process the transferred input information. For example, if it is determined that the input information is to be processed by the browser program 23, the input process unit 110 transfers the input information to the input analysis unit 111.

The function of the input process unit 110 is implemented by, for example, a process of writing input information in an area in the memory, such as the RAM 302, provided for the process of the browser program 23 under the control of the OS 22.

Determination regarding which program to process the input information will be described. If the input information includes positional coordinates information, the determination is made depending on the fact in which program the position coordinates information exists. If the input information is control information to the OS 22 (for example, the Esc key), it is determined that the OS 22 is the program which performs the process about the input information. If the input information includes character input from an input device, such as a keyboard, determination as to which program to process the input information is made in accordance with a program which is active. As described above, the process to transfer the input information to the browser program 23 (i.e., the process indicated by the arrow (1) in FIG. 5) is performed by the input unit 12 and the input process unit 110.

The input analysis unit 111 performs display control of a Web screen in accordance with the input information received from the input process unit 110 and in accordance with the browser program 23. For example, if the input information represents selection of link information in the Web screen or if the input information is input indicating performance of acquisition processing of the Web file 100 (e.g., confirm an input URL and confirm a searched keyword (keyphrase)), the input analysis unit 111 makes an acquisition request of the Web file 100 to the communication control unit 112 (the process of the arrow (2) in FIG. 5). In the character input mode, for example, a display process request for the character which has received as input information is made to the display control unit 115. In addition to these, if, for example, the input information is a transmission instruction of already input information (e.g., input of a button representing confirmation of input or transmit, or an input of an Enter key after inputting characters), a transmission request of already input information is made to the communication control unit 112.

The function of the input analysis unit 111 is implemented by, for example, the processor 301 making control in accordance with the input information in accordance with the browser program 23. For example, if the process in accordance with the input information is an acquisition request of the Web file 100, the function of the input analysis unit 111 is implemented by, for example, transferring control information including information representing that it is an acquisition request and information representing a storage location of the Web file 100 to the communication I/F 306.

The communication control unit 112 controls communication performed by the browser program 23. When communication control unit 112 receives an acquisition request of the Web file 100 from the input analysis unit 111, for example, the communication control unit 112 controls the communication unit 13 to generate an acquisition request message of the Web file 100 and transmit the generated acquisition request message to a designated storage location of the Web file 100.

The communication unit 13 transmits the acquisition request message in accordance with the control of the communication control unit 112. If the information is received, the communication unit 13 transfers the information to the communication control unit 112.

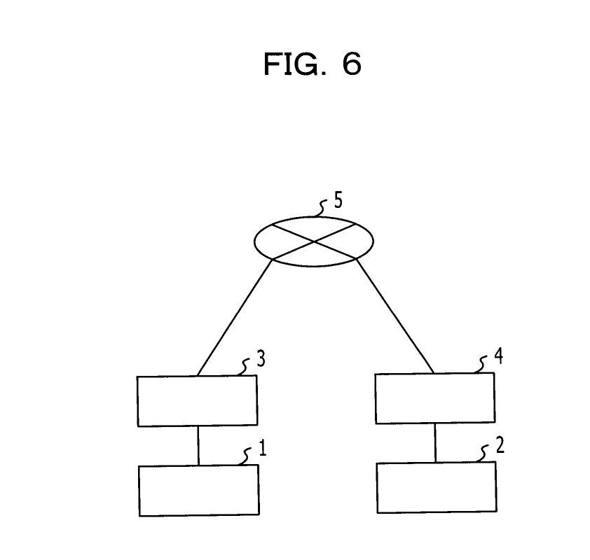

Processes of the communication control unit 112 and the communication unit 13 illustrated in FIG. 3 will be described with reference to an exemplary system including the computer 1 illustrated in FIG. 6. In the system illustrated in FIG. 6, the computer 1 is connected to a network 5 (for example, the Internet) via a relay device 3 and a Web server 2 is connected to the network 5 via a relay device 4. The relay device 3 and the relay device 4 are devices which read destination of received data and transmit the received data to a path in accordance with the destination.

When the communication control unit 112 generates the acquisition request message of the Web file 100 to be stored in the Web server 2, the communication unit 13 transmits the acquisition request message of which destination is the Web server 2 to the relay device 3. The relay device 3 then selects a path on a network in accordance with the destination of the acquisition request message and transmits the acquisition request message to the selected path. The Web server 2 includes hardware having the same hardware configuration as that of, for example, the computer 1 illustrated in FIG. 4.

When the acquisition request message is received via the relay device 4, the Web server 2 selects the Web file 100 in accordance with the received acquisition request message and transmits the selected Web file 100 to a source of transmission of the acquisition request message. The relay device 4 selects a path on the network in accordance with the destination of the received information and transmits the received information to the selected path in the same manner as the relay device 3.

When the Web file 100 transmitted from the Web server 2 is received via the relay device 3, the communication unit 13 transfers the received Web file 100 to the communication control unit 112.

(Process of Arrow (3) in FIG. 5)

When the Web file 100 for which an acquisition request is to be made is acquired from the communication unit 13, the communication control unit 112 makes a generation request of screen information about the acquired Web file 100 to the screen generation unit 113. The function of the communication unit 13 is implemented by, for example, the communication I/F 306 processing in accordance with the control of the processor 301.

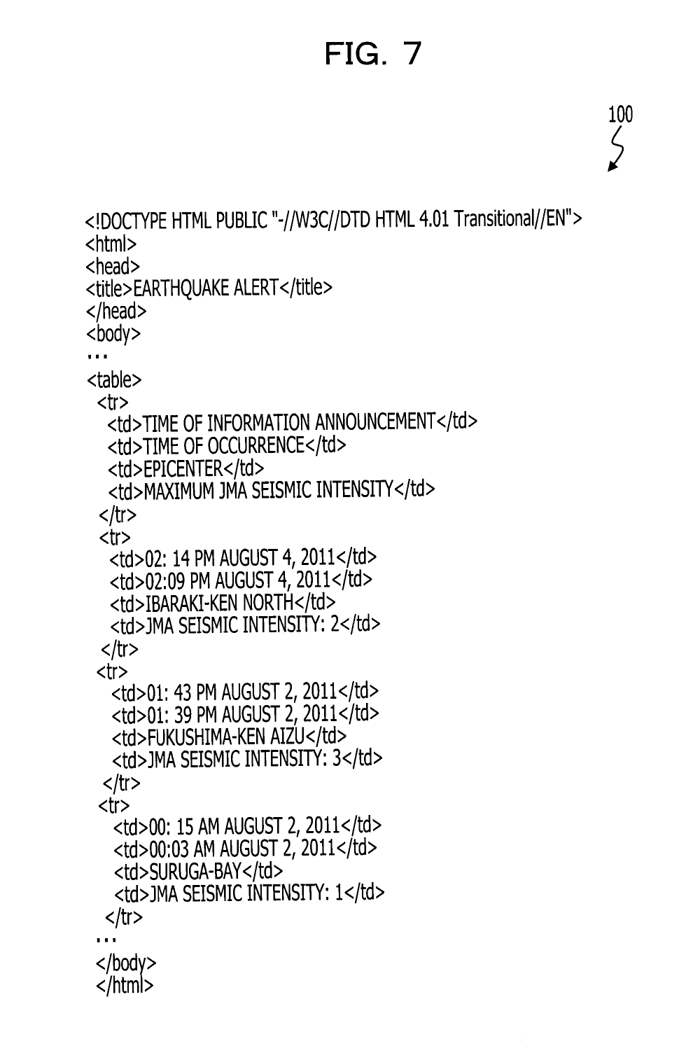

Regarding the acquired Web file 100, exemplary description is illustrated in FIG. 7. In description in which HTML is used, a hierarchical layout is defined in which display elements are described hierarchically. That is, an element described at a lower level of another element is described within a display range of that another element. For example, description of JavaScript (registered trademark) is included in the Web file 100.

The transmission function of the acquisition request message by the communication control unit 112 illustrated in FIG. 3 is implemented by, for example, the processor 301 making a control to generate a message, generate transmission data on the basis of the generated message, and cause the communication I/F 306 to transmit the transmission data. The message is generated in accordance with, for example, a communication protocol, such as HTTP. The transmission data is generated in accordance with, for example, a communication protocol, such as TCP/IP, and a lower-level protocol (which is constituted by a network which includes the computer 1 and the relay device 3). The reception function of the Web file 100 of the communication control unit 112 is implemented by the processor 301 further controlling a reception process of the communication I/F 306, processing the received data in accordance with the communication protocol and extracting the Web file 100.

When a generation request of screen information is received from the communication control unit 112, the screen generation unit 113 extracts information to be arranged in the same display form (i.e., a correction candidate) among display elements included in the acquired Web file 100. For example, the screen generation unit 113 analyzes a child-parent relationship (i.e., a hierarchical structure) of the elements of document data of which display form is specified by the hierarchical structure of the display elements, and extracts a portion which includes a predetermined or greater number of elements of the same type having a common parent element. The elements of the same type having a common parent element are, for example, records included in a table or text elements included in a list. For example, in HTML, the type of each element is determined in accordance with tag information attached before and after each element. For example, an element to which tag information <tr> is attached is determined to be an element of a record included in a table; an element to which tag information <Ii> is attached is determined to be an element of a list; and an element to which tag information <p> is attached is determined to be an element representing a paragraph in text. A <tr>element is a child element of a <table>element and a <li>element is a child element of a <ul>element or an <ol>element.

In a case in which the Web file 100 includes no portion in which a predetermined or greater number of elements of the same type having a common parent element is included, the screen generation unit 113 generates screen information in accordance with the description of the Web file 100 and makes a display request of screen information to the display control unit 115.

In a case in which the Web file 100 includes a portion in which a predetermined or greater number of elements of the same type having a common parent element is included, the screen generation unit 113 extracts that portion and transfers information representing the Web file 100 to the storage control unit 114. The information which represents the Web file 100 is, for example, a URL of the Web file 100 or a title name of the Web file 100.

The extract function by the screen generation unit 113 is implemented by, for example, the processor 301 reading sequentially the Web file 100 developed on the memory, such as the RAM 302, and comparing or collating the read information.

When the information which represents the Web file 100 is received from the screen generation unit 113, the storage control unit 114 reads condition information which has been stored in the storage unit 14 in correlation with the information which represents the Web file 100 (processes indicated by the arrows (4) and (5) of in FIG. 5) and transfers the read condition information to the screen generation unit 113.

The function of the storage control unit 114 is implemented by, for example, the processor 301 making control to read information corresponding to the Web file 100 from the memory, such as the RAM 32, or from a file stored in the recording medium 305. The function of the storage unit 14 is implemented by, for example, by the information being read from and written in the RAM 302 or the recording medium 305 by the control of the processor 301.

The screen generation unit 113 extracts an element which satisfies conditions in accordance with condition information received from the storage control unit 114 from the previously extracted portion of the Web file 100. The screen generation unit 113 generates screen information of the Web file 100 except for the extracted element. If no element which satisfies the conditions is extracted, the screen generation unit 113 generates screen information in accordance with the Web file 100. The screen generation unit 113 makes a display request of the generated screen information to the display control unit 115.

A function to generate the screen information by the screen generation unit 113 is implemented by, for example, the processor 301 arranging images of each element included in the Web file 100 in accordance with position information which represents the position of each element, and generating the entire image (screen information) of the Web file 100 on the memory, such as the RAM 302.

The display control unit 115 controls the display unit 15 to display the screen information which is generated by the screen generation unit 113 (arrow (6) in FIG. 5). The function of the display control unit 115 is implemented by the processor 301 controlling the output I/F 308 to display the screen information generated by the process of the browser program 23 on the display area allocated to the browser program 23 by the process of the OS 22. The function of the display unit 15 is implemented by the output I/F 308 performing a process in accordance with the control of the processor 301. Alternatively, the display unit 15 may include a display device and the display unit 15 displays the screen information. The display function of the display unit 15 is implemented by, for example, the display device performing image display in accordance with the process of the output I/F 308.

Since each constitution of the computer 1 performs the process described above, the screen information in accordance with conditions illustrated in FIG. 2 is displayed in the computer 1 even if the Web file 100 representing the screen information illustrated in FIG. 1 is acquired.

The hardware illustrated in FIG. 4 will be described in detail.

The RAM 302 is a rewritable memory device which is, for example, semiconductor memory, such as Static RAM (SRAM) and Dynamic RAM (DRAM). Flash memory may also be used instead of the RAM. The ROM 303 includes Programmable ROM (PROM). The drive device 304 is a device which at least either reads information from or writes information in the recording medium 305. The recording medium 305 stores the information written by the drive device 304. The recording medium 305 is, for example, a recording medium, such as hard disk, a compact disc (CD), a digital versatile disc (DVD) and a Blu-ray disc. In an exemplary configuration, the computer 1 includes the drive device 304 and the recording medium 305 for each of the plural types of recording media.

The input device 311 is a device which transmits an input signal in accordance with input manipulation. The input device 311 is, for example, a key device, such as a keyboard and buttons attached to a main body of the computer 1, or a pointing device, such as a mouse and a touch panel. The output device 312 is a device which outputs information in accordance with the control of the computer 1. The output device 312 is, for example, an image output device (display device), such as a display, or an audio output device, such as a speaker. For example, an input/output device, such as a touchscreen, is used as the input device 311 and the output device 312.

The input device 311 and the output device 312 may be integrated in the main body of the computer 1. In that case, the input unit 12 includes, for example, the input I/F 306 and the input device 311 and the display unit 15 includes, for example, the output I/F 307 and the output device (display device) 312.

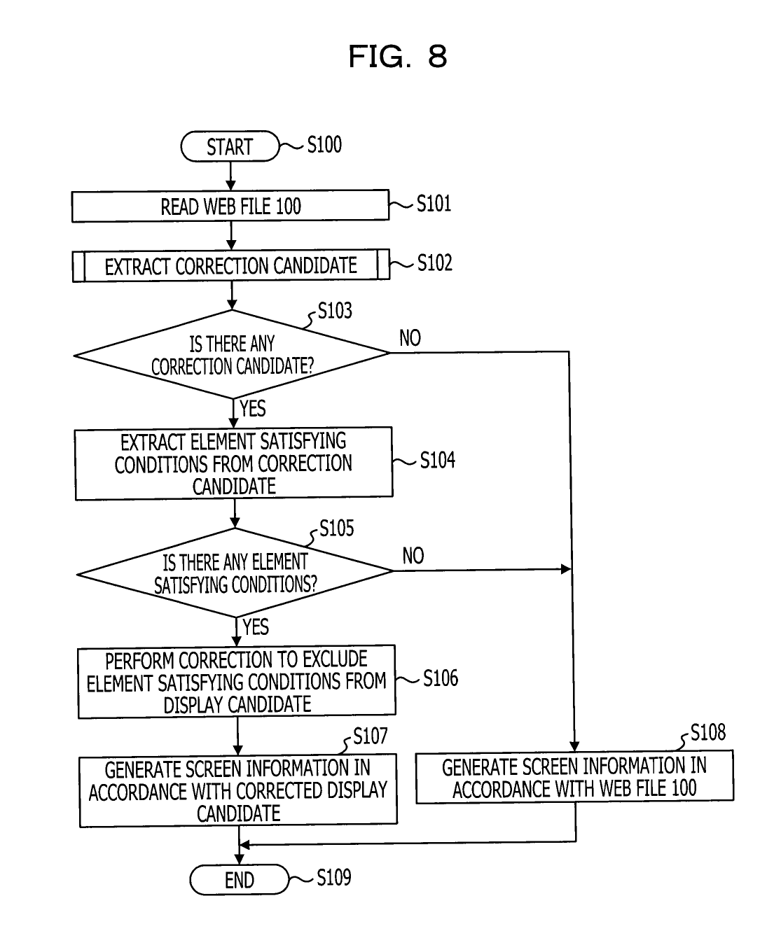

The process of the screen generation unit 113 will be described in detail. FIG. 8 illustrates an exemplary process flow of the screen generation unit 113.

When the screen generation unit 113 receives, from the communication control unit 112, the Web file 100 acquired in response to the acquisition request and receives the screen generation request, the screen generation unit 113 starts a screen information generation process (S100). In the screen information generation process, the screen generation unit 113 reads the Web file 100 into the memory (S101). The data read in this process includes, for example, a data structure referred to as a document object model (DOM) tree reflecting the document structure of the Web file. Details of the DOM tree structure will be described later.

After the Web file 100 is read, the screen generation unit 113 extracts, from the Web file 100, a portion which includes a predetermined or greater number of elements which include a common parent element (S102). The portion is extracted as a correction candidate which is a candidate to be excluded from display candidates depending on whether the specified conditions are satisfied. The specified conditions are, for example, defined previously or input by a user at the time of reading of the Web file 100 or other timing. The process of S102 may be a process to extract, as the correction candidate, a portion which includes a predetermined or greater number of the same type of elements that include a common parent element. Even in a portion which includes no common parent element, a portion in which a predetermined or greater number elements of the same type are consecutively arranged may be extracted as the correction candidate. In this manner, for example, the portion in which the element to which the tag information <tr> is attached is repeated a predetermined or greater number of times is extracted. Alternatively, the process of S102 may be a process to extract the portion in accordance with comparison between the elements. That is, the extraction may be made in accordance with whether a predetermined or greater number of elements that have been determined to be similar to each other are consecutively arranged. After the process of S102, the screen generation unit 113 determines whether any correction candidate has been extracted in the process of S102 (S103). If no correction candidate has been extracted in the process of S102 (S103: No), the screen generation unit 113 generates the screen information in accordance with the content of the Web file 100 read into the memory (S108). After the process of S108, the screen generation unit 113 makes a display request of the generated screen information to the display control unit 115 and terminates the process (S109).

If a correction candidate has been extracted in the process of S102 (S103: Yes), the screen generation unit 113 extracts an element which satisfies the specified conditions from among the elements included in the extracted correction candidate (S104). After the process of S104, the screen generation unit 113 determines whether any element which satisfies the specified conditions is extracted from among the elements included in the correction candidate (S105). If no element which satisfies the specified conditions is extracted from among the elements included in the correction candidate (S105: No), the screen generation unit 113 performs a process of S108, makes a display request of the generated screen information to the display control unit 115 and then terminates the process (S109).

If any element which satisfies the specified conditions is extracted from among the elements included in the correction candidate (S105: Yes), the screen generation unit 113 makes a correction to exclude, from the display candidate, information about the element which satisfies the conditions from among the information of the Web file 100 read into the memory (S106). After the process of S106, the screen generation unit 113 generates screen information in accordance with the information on the corrected Web file 100 (S107), makes a display request of the generated screen information to the display control unit 115 and then terminates the process (S109).

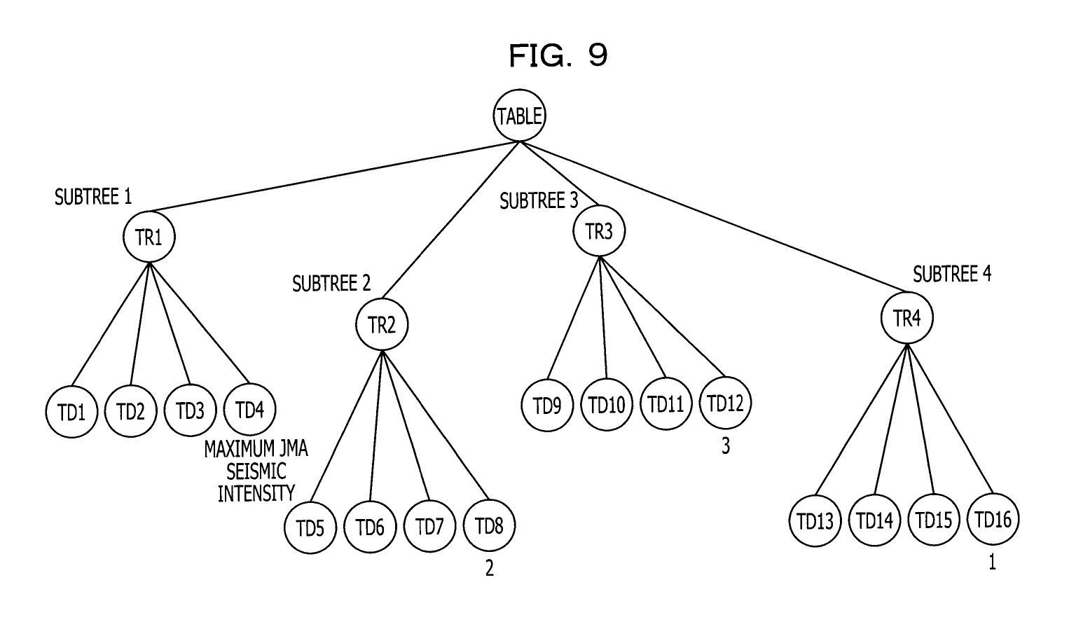

Next, a data structure which is used when the screen generation unit 113 reads the Web file 100 into the memory will be described. This data structure is referred to as a DOM tree. FIG. 9 illustrates exemplary generation of a DOM tree of description (description from <table> to </table>) about the table T10 in FIG. 7.

In the example of FIG. 7, a <tr>tag is described on the next line of a <table>tag. Since the <tr>tag is inserted between the <table>tag and a </table>tag, for example, the screen generation unit 113 determines that the element to which the <tr>tag is attached is a child element of the element to which the <table>tag is attached. The screen generation unit 113 then generates information about an element tr1 as a child element of an element table. Since the Web file 100 includes plural elements inserted between the <tr>tag and a </tr>tag, the screen generation unit 113 allocates identification information tr1, tr2 and so forth to these elements. The screen generation unit 113 generates information about the element tr2, element tr3 and so forth, like the element tr1, as children elements of the element table.

Plural children elements inserted between a <td>tag and a </td>tag exist also between a <tr>tag and a </tr> tag of the element tr1. The screen generation unit 113 allocates identification information of td1, td2 and so forth to each of the plural children elements and generates information about each element.

As described above, when the Web file 100 of FIG. 7 is analyzed with the elements inserted between tags representing start and end of a certain element being considered as the children elements of that element, a tree structure of FIG. 9 is obtained. For example, an element td4 includes a character string of “maximum JMA seismic intensity,” an element td8 includes a character string of “2,” an element td12 includes a character string of “3” and an element td16 includes a character string of “1.”

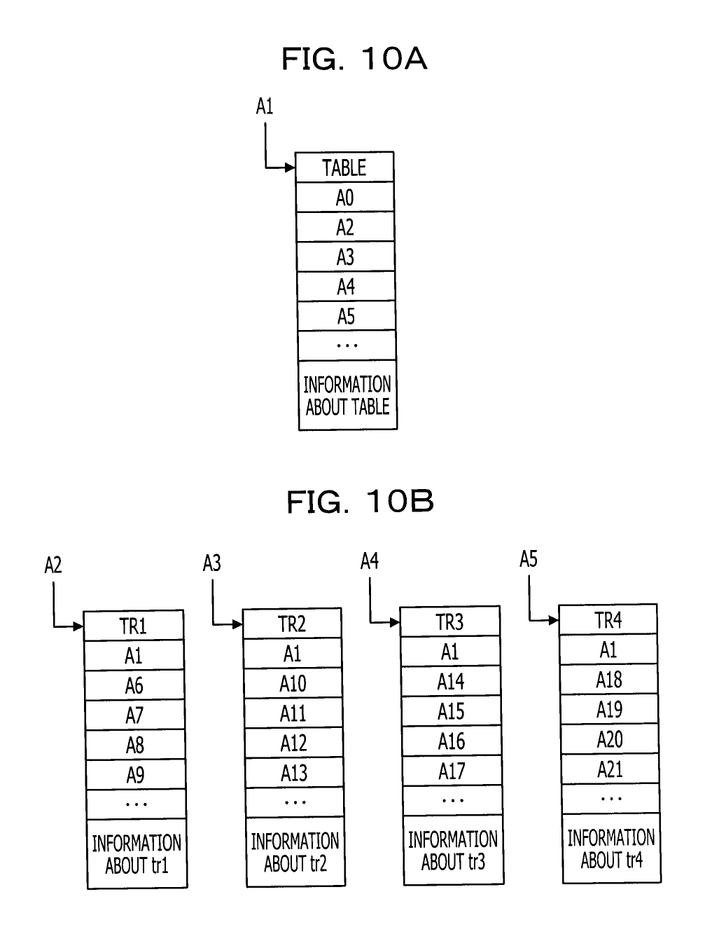

The tree structure illustrated in FIG. 9 is provided to describe a child-parent relationship between elements: exemplary data structures actually stored in the memory are illustrated in FIGS. 10 to 12.

FIG. 10A illustrates a data structure of information about the element table. Identification information of the element table is stored in an area indicated by a pointer A1. In the next area, a pointer (A0) indicating a parent element is stored. In the example of FIG. 7, the parent element of the element table is an element body. However, depending on description of a portion herein omitted and represented by ( . . . ) in FIG. 7, the parent element of the element table is not necessarily the element body. Pointers indicating children elements (A2 to A5) are stored next to the pointer indicating the parent element. The number of the pointer indicating the parent element is one but a plurality of pointers indicating children elements may be stored. Information about the element table (such as layout setting (setting of position, size, etc.) of the table) is stored at the end of the data structure.

FIG. 10B illustrates data structures of information about the elements tr1 to tr4. Information to identify tr1 is stored in an area indicated by the pointer A2 which indicates a child element of the element table. Subsequently, the pointer A1 indicating a parent element of the element tr1 is stored, and pointers indicating children elements (A6 to A9) are stored. Information about the element tr1 (such as the layout setting of the records) is stored at the end of the data structure. Elements tr2 to tr4 each include, in the same manner as the data structure of the element tr1, identification information, a pointer indicating a parent element, pointers indicating children elements, and information about the element (such as layout setting).

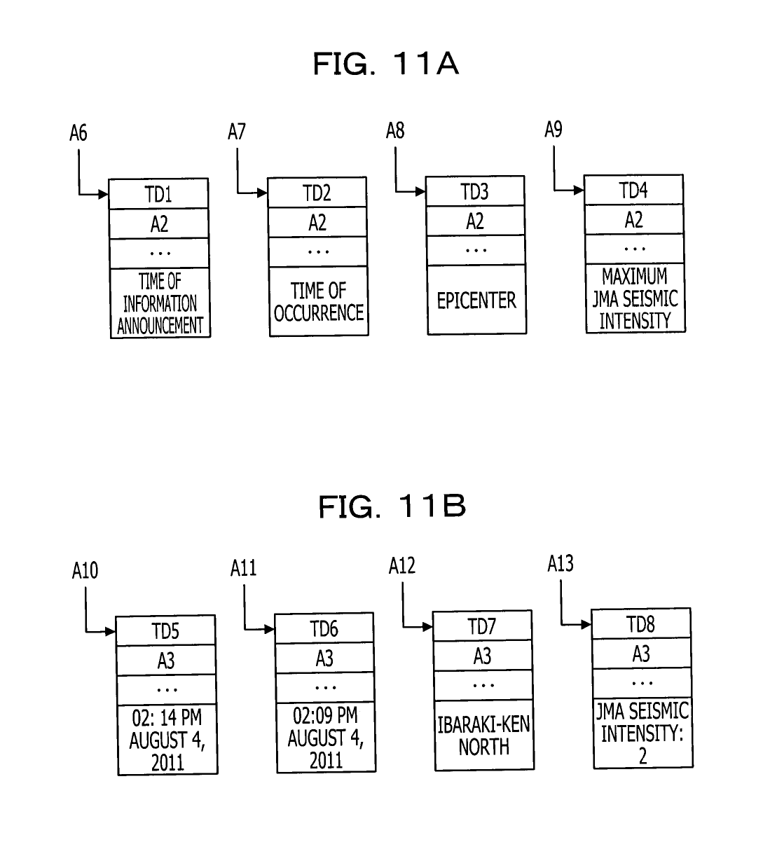

FIG. 11A illustrates a data structure of information about elements td1 to td4. Information to identify td1 is stored in an area indicated by a pointer A6 which indicates a child element of the element tr1. Subsequently, a pointer A2 which indicates a parent element of the element td1 is stored. Since the element td1 has no child element, no pointer indicating a child element exists. Information related to the element td1 (such as a character string to be displayed) is stored at the end of the data structure. Elements td2 to td4 each include, in the same manner as the data structure of the element td1, identification information, a pointer indicating a parent element and information about the element (such as a character string to be displayed).

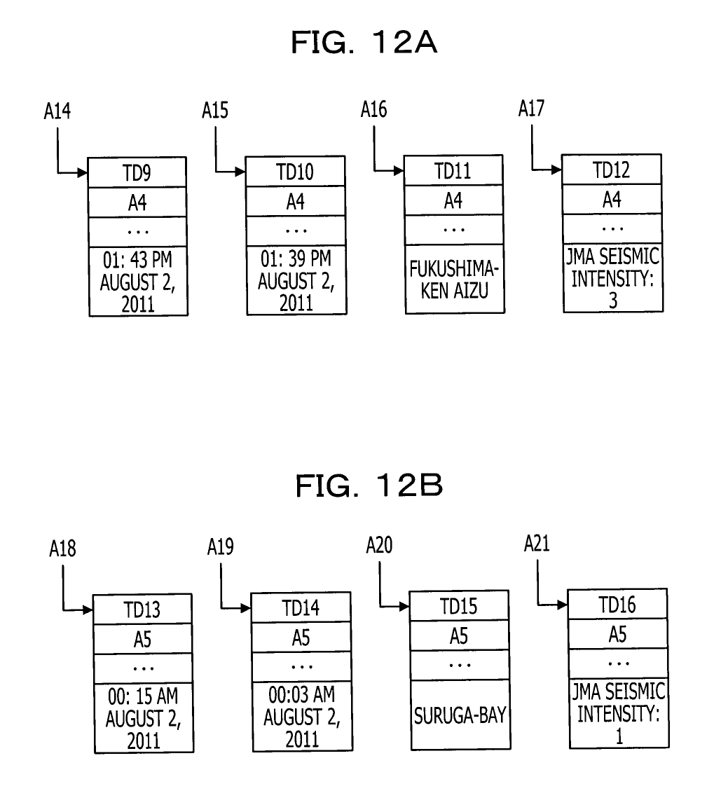

FIG. 11B illustrates data structures of information about elements td5 to td8. Elements td5 to td8 each include, in the same manner as the data structure of the element td1, identification information, a pointer indicating a parent element and information about the element (such as a character string to be displayed). FIG. 12A illustrates a data structure of information about elements td9 to td12. Elements td9 to td12 each include, in the same manner as the data structure of the element td1, identification information, a pointer indicating a parent element and information about the element (such as a character string to be displayed). FIG. 12B illustrates data structures of information about elements td13 to td16. Elements td13 to td16 each include, in the same manner as the data structure of the element td1, identification information, a pointer indicating a parent element and information about the element (such as a character string to be displayed).

Creation of a DOM tree from a read Web file 100 is an exemplary process: the screen generation unit 113 has only to read the Web file 100 in a state in which a child-parent relationship of each element included in the Web file 100 is understandable.

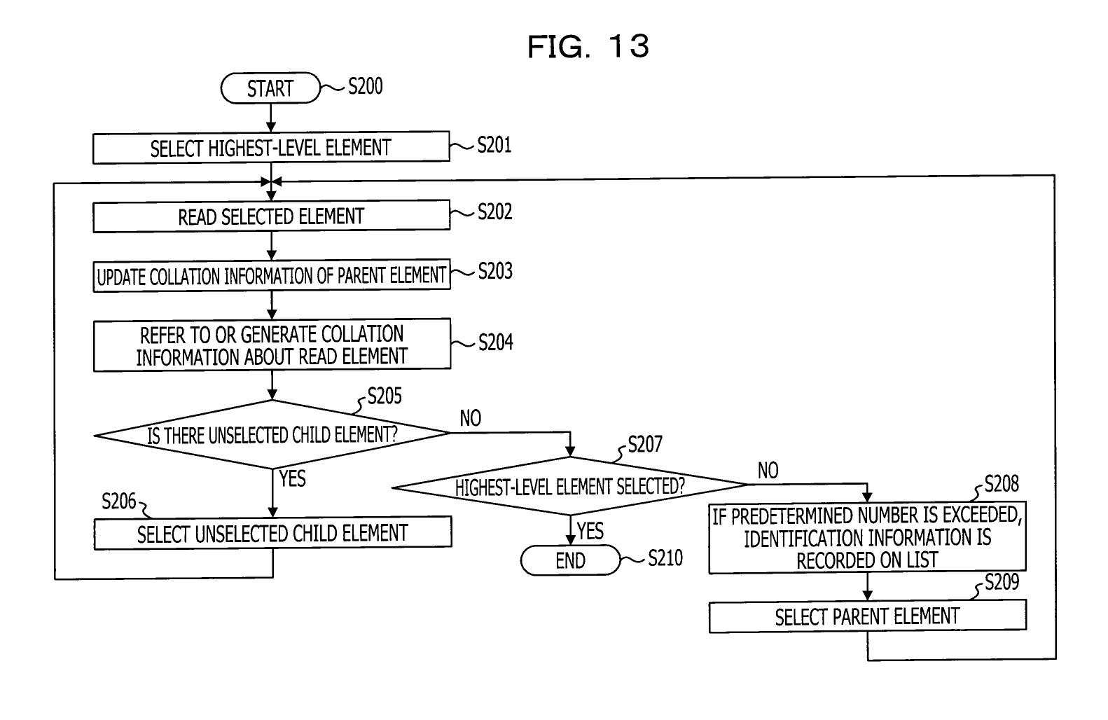

When the Web file 100 is read and the DOM tree is created, the screen generation unit 113 performs a process to extract the correction candidate. FIG. 13 illustrates an exemplary process flow to extract a correction candidate.

When the DOM tree is created, the screen generation unit 113 creates a list in which pointers indicating parent elements of elements of correction candidates are to be recorded, and starts an extraction process of the correction candidate (S200). First, the screen generation unit 113 selects a highest-level element in the DOM tree (S201). Next, the screen generation unit 113 reads information about the selected element (S202). The information about the selected element is, for example, information about each element illustrated in FIGS. 10A to 12B.

The screen generation unit 113 specifies the parent element in accordance with the pointer indicating the parent element included in the information read in S202, and updates collation information about the parent element (S203). The collation information is information generated for each element in the next process of S204. Since the highest-level element is selected and no parent element exists the first time, the process of S203 is not performed.

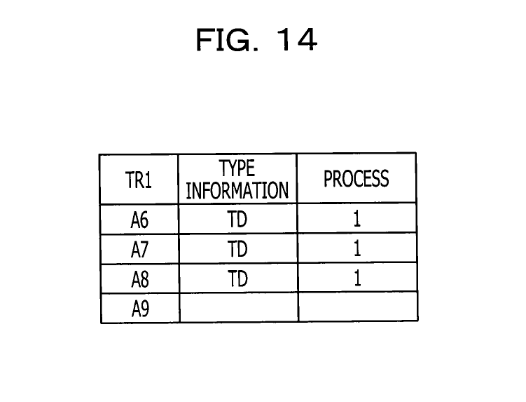

After the process of S203, the collation information about the read element is referred to or generated (S204). If no collation information has been generated, the screen generation unit 113 generates collation information about the selected element in performing the process of S204. The collation information includes, for example, the information illustrated in FIG. 14, representing children elements of the selected element, representing the type of each child element, and representing whether each child element has been selected. Even if the collation information is already generated at the time of the process of S204, the screen generation unit 113 reads the collation information and determines whether any unselected child element exists (S205). Also when the collation information is generated, the screen generation unit 113 refers to the generated collation information and determines whether any unselected child element exists (S205).

The collation information illustrated in FIG. 14 is related to the element tr1. A “process” column of the collation information of FIG. 14 represents that children elements td1, td2 and td3 of the element tr1 have been selected. A “type information” column indicates that each of the children elements td1, td2 and td3 is the element to which the <td>tag has been attached.

If it is determined in S205 that any unselected child element exists (S205: Yes), the screen generation unit 113 selects the unselected child element (S206) and performs the process of S202 again.

If it is determined in S205 that no unselected child element exists (S205: No), the screen generation unit 113 determines whether the selected element is a highest-level element (S207). If it is determined in S207 that the selected element is a highest-level element (S207: Yes), the screen generation unit 113 terminates the extraction process (S210) and determines whether any correction candidate exists with children elements of the element recorded in the list as elements of the correction candidate (S103).

If it is determined in S207 that the selected element is not a highest-level element (S207: No), the screen generation unit 113 refers to the collation information of the selected element and, in accordance with the collation information, records the pointers which indicate storage locations of the information about the selected elements in the list (S208). In S208, the screen generation unit 113 counts the number of the selected children elements included in the collation information. If the number of the selected children elements included in the collation information is equal to or greater than a predetermined number, the screen generation unit 113 records, in the list, the pointers which indicate storage locations of the information about the selected elements. Alternatively, the screen generation unit 113 refers to type information included in the collation information and counts the number of pieces of information of the same type. If the largest number of pieces of information of the same type is equal to or greater than a predetermined number, the screen generation unit 113 records, in the list, the pointers which indicate storage locations of the information about the selected elements. After the process of S208, the screen generation unit 113 selects the parent element of the selected element (S209). After the process of S209, the screen generation unit 113 performs the process of S202 again.

By the process described above, the screen generation unit 113 makes a list of the identification information of the parent element of the elements of the correction candidate. Thus, the pieces of information arranged in a common form can be processed. The screen generation unit 113 performs the process of S104 in accordance with the created list. For example, the screen generation unit 113 reads the information about the element in accordance with the listed pointer, refers to the information about each child element in accordance with the pointer of the child element included in the read information, and extracts the element which satisfies the conditions from among the correction candidate.

The screen generation unit 113 performs a process to exclude the elements extracted in S104 from the display candidate depending on whether the specified conditions are satisfied. When, for example, a process to exclude the element tr1 from the display candidate is performed, the screen generation unit 113 deletes the pointer A2 indicating the element tr1 from the information related to the parent element table of the element tr1 illustrated in FIG. 10A. At the time of, for example, deleting the pointer A2 indicating the element tr1, the screen generation unit 113 stores information in which the pointer A1 indicating the parent element table and the pointer A2 indicating the element tr1 are correlated to each other in an unillustrated display inhibition list. By adding the pointer A2 again to the area in which the children elements of the element table which the pointer A1 indicates are stored with reference to the display inhibition list, the screen generation unit 113 can restore the elements which have been excluded from the display candidate.

For example, the screen generation unit 113 corrects layout setting of each element in accordance with the number of elements to be displayed. When performing the process to exclude the element tr1 from the display candidate, the screen generation unit 113 corrects the vertical width of the display area of the element table to reduce in accordance with the number of children elements included in the element table. The number of children elements included in the element table is determined by, for example, the number of pointers of the children elements included in the information about the element table.

By the process described above, the screen information from which information is excluded in accordance with the specified condition from among the information arranged in a common display form in the Web file 100 is generated.

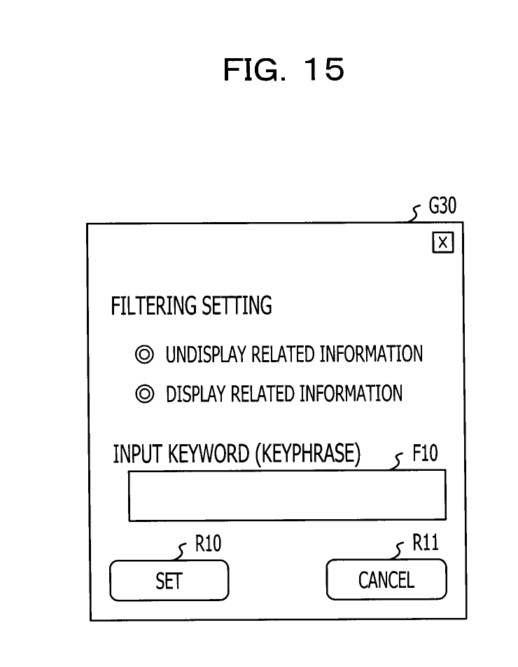

Specification of conditions will be described in detail with reference to FIGS. 15 to 17. In a case in which, for example, a screen of the browser program 23 includes a button display representing condition input and the input analysis unit 111 detects input to the button, an input screen, such as one illustrated in FIG. 15, is displayed by the display control unit 115.

An input screen G30 illustrated in FIG. 15 includes an item with which a viewer is asked to input filtering setting, a keyword (keyphrase) entry field F10, an “Enter” button R10 representing confirmation of the input, and a “Cancel” button R11 representing cancel of the input. The filtering setting is performed to specify a process to be performed: for example, it is determined whether a portion related to a keyword (keyphrase) is displayed or excluded.

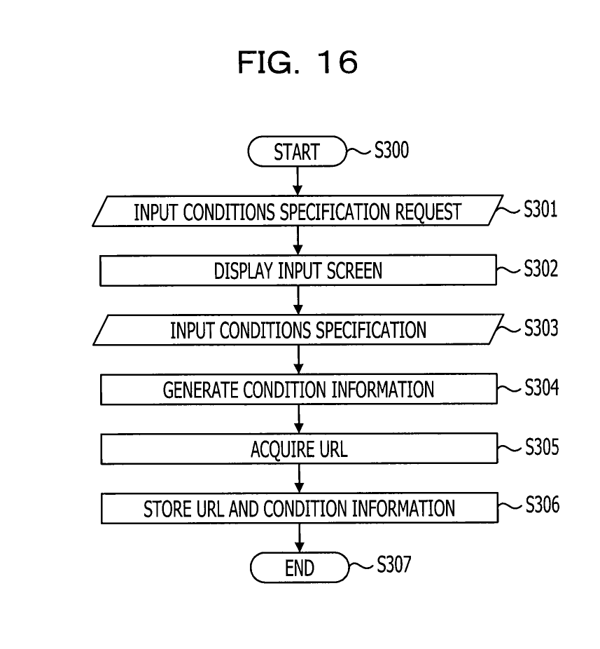

Specification of conditions in accordance with the information input on, for example, the input screen illustrated in FIG. 15 is performed along, for example, a process flow illustrated in FIG. 16. In a state in which the browser program 23 is started (S300), when a condition specification request is made (S301), the display control unit 115 displays the input screen G30 on the display unit 15 (S302). In the process of S301, if the input analysis unit 111 determines, for example, that the user input detected by the input unit 12 is within the display area, such as a button representing condition input, it is determined that a condition specification request has been input.

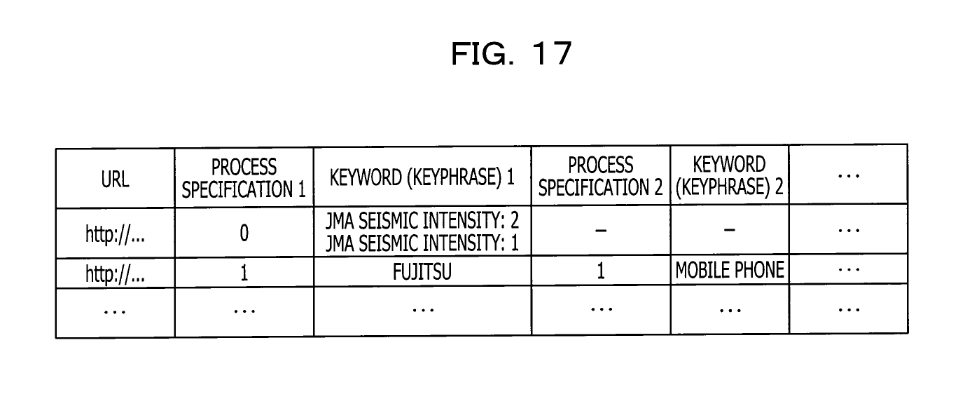

When input is made in the screen displayed in the process of S302 (S303), condition information in accordance with the detail of input in S303 is generated (S304). For example, in the process of S303, if any input in “Enter” button on the input screen G30 is detected, the input analysis unit 111 determines that the process of S303 has been performed. The condition information to be generated will be described later with reference to FIG. 17.

The input analysis unit 111 acquires information for the identification of the Web page which is currently displayed on the display unit 15 by the process of the browser program 23 (for example, a URL) (S305). After the process of S305, the storage control unit 114 stores, in a correlated manner, the information acquired by the input analysis unit 111 and the condition information generated in S303 in the storage unit 14 (S306). The conditions are thus specified and the process is terminated (S307).

FIG. 17 is exemplary information which is generated by the process of S304 of FIG. 16 and stored in the storage unit 14 by the process of S306. For example, “keyword (keyphrase)” is information input in the entry field F10. “Process specification” is information with which it is specified, to the correction candidate, whether an element which includes the “keyword (keyphrase)” is displayed or excluded. When process specification is performed, it is determined which condition has been specified in accordance with the filtering setting input in the screen information G30 illustrated in FIG. 15. As illustrated in FIG. 17, plural sets of “Process specification” and “keyword (keyphrase)” may be defined. If plural keywords (keyphrases) are input in the entry field F10, plural keywords (keyphrases) are stored in the “keyword (keyphrase)” entry. For example, if “JMA seismic intensity 2, JMA seismic intensity 1” is input in the entry field F10, two keywords (keyphrases) of “JMA seismic intensity 2” and “JMA seismic intensity 1” are stored in the “keyword (keyphrase)” entry as illustrated in FIG. 17.

The information input in the entry field F10 may be stored directly as the “keyword (keyphrase),” or may be analyzed to generate a keyword (keyphrase) and the generated keyword (keyphrase) may be stored. For example, words specifying ranges, such as “lower than or equal to,” “equal to or greater,” “from” “to,” and operators corresponding to each of these words are registered previously. When “JMA seismic intensity 3 or lower” is input, the operator corresponding to the “lower than or equal to” is applied to the numerical value “3” and keywords (keyphrases) “JMA seismic intensity 2” and “JMA seismic intensity 1” are generated. The method of generating the keyword (keyphrase) in accordance with the information input in the entry field F10 is not limited to the analysis described above: any suitable analysis routine may be used.

If further condition information is generated about a URL to which the condition information has already been related, the storage control unit 114 stores plural pieces of condition information in the storage unit 14 in correlation with the URL. For example, in the example of FIG. 17, if conditions including a keyword (keyphrase) “mobile phone” are input in a state in which a keyword (keyphrase) “FUJITSU” has already been stored in the storage unit 14, the storage control unit 114 stores the keyword (keyphrase) “mobile phone” in the storage unit 14 in further correlation with the URL.

Next, the determination process as to whether each element included in the correction candidate satisfies specified conditions in the process of S104 of FIG. 8 will be described in detail. In this determination process, each element included in the correction candidate is selected sequentially, and it is determined for each selected element whether it satisfies the specified conditions.

A first method of determining whether a selected element satisfies conditions includes determination as to whether the selected element includes a keyword (keyphrase) represented by condition information. That is, if the selected element includes the keyword (keyphrase), the screen generation unit 113 determines that the selected element satisfies the conditions and if the selected element does not include the keyword (keyphrase), the screen generation unit 113 determines that the selected element does not satisfy the conditions.

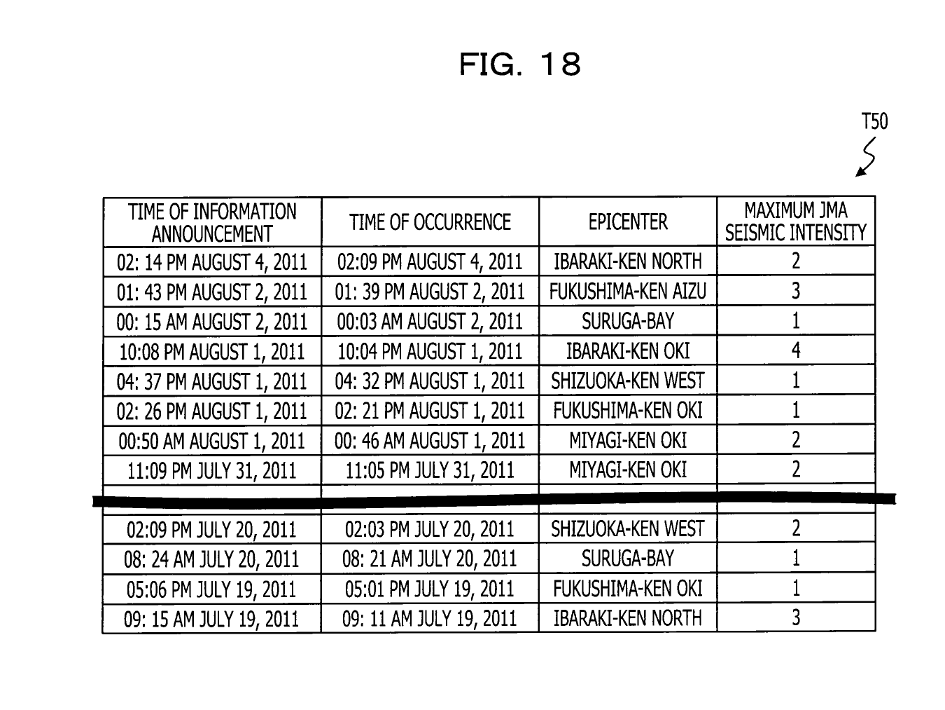

In a case, for example, in which the table T10 included in the screen information G10 is a table T50 illustrated in FIG. 18, records (i.e., elements) corresponding to the keyword (keyphrase) “JMA seismic intensity 1” or “JMA seismic intensity 2” are not extracted when the first method is used. Although the numerical values belonging to the column of “maximum JMA seismic intensity” represent JMA seismic intensity, these are just data representing numerical values and therefore do not correspond to the keywords (keyphrases) “JMA seismic intensity 1” and “JMA seismic intensity 2.” In contrast, in the display form of the table, words related to the content of each column often exist in the first row of the record. Then, as a second method, the screen generation unit 113 determines that the conditions are satisfied when, for example, each record includes a part of a keyword (keyphrase) and another part of the keyword (keyphrase) is included in the first row. As a third method, for example, the screen generation unit 113 determines that the conditions are satisfied when it is determined by either the first method or the second method that the conditions are satisfied.

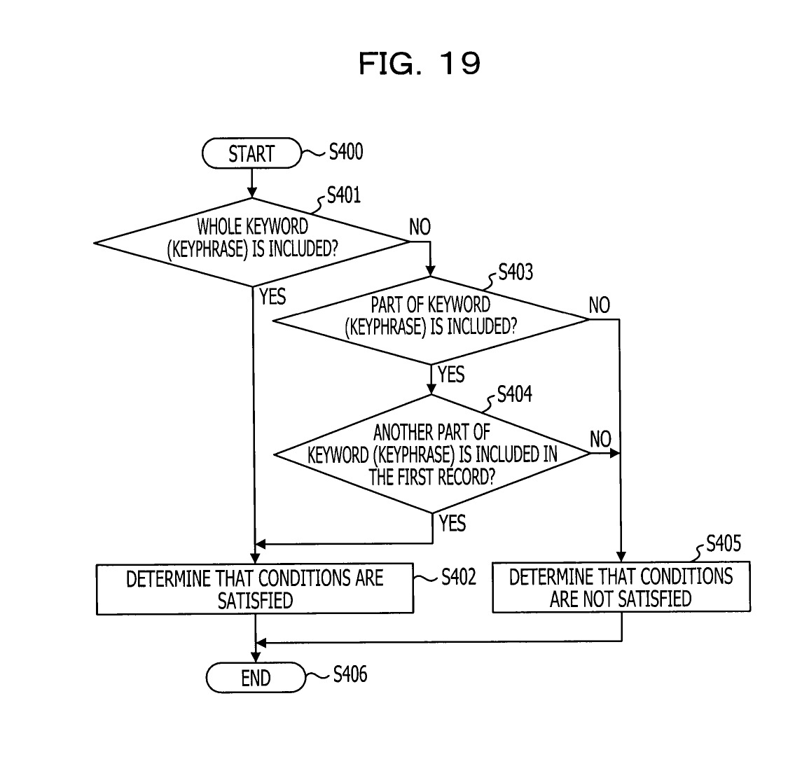

FIG. 19 illustrates an exemplary determination process flow to determine whether an element satisfies conditions by the third method described above. In the process of S104 FIG. 8, elements are sequentially selected from among the correction candidate (S400). When an element is selected from among the correction candidate, the screen generation unit 113 determines whether the selected element includes a whole keyword (keyphrase) (S401).

If the selected element includes the whole keyword (keyphrase) (S401: Yes), it is determined that the conditions are satisfied (S402) and the determination process is terminated (S406). If the selected element does not include the whole keyword (keyphrase) (S401: No), it is then determined whether the selected element includes a part of the keyword (keyphrase) (S403). If it is determined in S403 that the selected element includes a part of the keyword (keyphrase) (S403: Yes), it is then determined whether another part of the keyword (keyphrase) which has not been included in the selected element is included in the first record (S404). The first record is, for example, a child element located next to the parent element of the selected element (for example, when the selected element is tr3, the first record is the child element tr1 located next to the parent element table of tr3).

If the selected element does not include any part of the keyword (keyphrase) (S403: No), or if another part of the keyword (keyphrase) which has not been included in the selected element is not included in the first record (S404: No), the screen generation unit 113 determines that the conditions are not satisfied (S405). After the determination of S405, the process is terminated (S406).

The process to inhibit display is implemented as a function of the browser program 23 in the embodiment described above. Alternatively, such a function may be provided as an add-in program implemented in cooperation with the browser program 23.

Since the storage control unit 114 stores the condition information and the URL in the storage unit 14 in a correlated manner, the computer 1 may perform filtering when the browser program 23 is started again using the condition information which is set last time.

The configuration of the embodiment of the present disclosure is not limited to that described above and may be suitably changed within the scope in which the disclosure is practiced.

By the above-mentioned browser performs display control, the user may quickly identify the desired information. Therefore, in a computer to perform display control, the period that a Web file including enumerations of information is loaded into memory is reduced.

In addition, Web content creators may not necessary provided for each Web file display control mechanism. Since no mechanism is provided in the Web file itself is acquired through communication, the amount of data to be communicated is reduced. Then, the load to the buffer memory used for communication and bandwidth may be suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable recording medium storing display control program that causes a computer to execute a procedure, the procedure comprising:
obtaining displaying data; and
displaying the displaying data, wherein
when a displaying element group includes a specific number or more of display elements, the displaying data includes display elements which are included in the display element group and satisfy a specified condition.

2. The recording medium according to claim 1, wherein
the display element group is included in a document data, and
a display form of the display element group is specified in accordance with a piece of instruction information included in the document data.

3. The recording medium according to claim 1, wherein
each display element of the display element group is specified a common display form.

4. The recording medium according to claim 1, wherein
each display element of the display element group is related to type information indicating type of the display element, and
in a case that each display element of the display element group is related to common type information and the display element group includes the specified number or more of consecutively arranged display elements, the displaying data includes the display elements.

5. The recording medium according to claim 1, wherein
the display element group is specified as a table or a list, and includes the specified number or more of consecutively arranged display elements.

6. The recording medium according to claim 1, the procedure further comprising:
correcting a layout to reduce the size of a display area of the display element group not involving the display elements.

7. The recording medium according to claim 1, the procedure further comprising:
displaying an input form on the display device for specifying the specific condition.

8. The recording medium according to claim 7, wherein
the specific condition is satisfied in a case that a display element, included in the display element group, includes input information input on the input form.

9. The recording medium according to claim 7, the procedure further comprising:
generating a plurality of keywords based on input information input on the input form, wherein
the specific condition is satisfied in a case that a display element, included in the display element group, includes at least one of the plurality of keywords.

10. A display control method, comprising:
obtaining displaying data; and
displaying the displaying data by a processor, wherein
when a displaying element group includes a specific number or more of display elements, the displaying data includes display elements which are included in the display element group and satisfy a specific condition.

11. The display control method according to claim 10, further comprising:
displaying an input form on the display device for specifying the specific condition.

12. The display control method according to claim 11, wherein
the specific condition is satisfied in a case that that a display element, included in the display element group, includes input information input on the input form.

13. The display control method according to claim 11, further comprising:
generating a plurality of keywords based on input information input on the input form, wherein
the specific condition is satisfied in a case that a display element, included in the display element group, includes at least one of the plurality of keywords.

14. A computer comprising:
a display device; and
a processor that executes a procedure, the procedure including:
obtaining displaying data; and
displaying the displaying data on the display device, wherein
when a displaying element group includes a specific number or more of display elements, the displaying data includes display elements which are included in the display element group and satisfy a specific condition.

15. The computer according to claim 14, the procedure further comprising:
displaying an input form on the display device for specifying the specific condition.

16. The computer according to claim 15, wherein
the specific condition is satisfied in a case that a display element, included in the display element group, includes input information input on the input form.

17. The computer according to claim 15, the procedure further comprising:
generating a plurality of keywords based on input information input on the condition input screen, wherein
the specific condition is satisfied in a case that a display element, included in the display element group, includes at least one of the plurality of keywords.
